(19) United States
(12) Patent Application Publication
(10) Pub. No.: US 2020/0326128 A1
(43) Pub. Date: Oct. 15, 2020

(54) INFRARED BAKING DEVICE AND ELECTRONIC COMPONENT BAKING METHOD USING SAME

(71) Applicants: YONEKURA MFG. Co., LTD., Osaka (JP); DiV Co., LTD., Kagoshima (JP)

(72) Inventors: Yasuhiro Onishi, Osaka (JP); Sadayuki Ibusuki, Kagoshima (JP)

(21) Appl. No.: 16/913,926

(22) Filed: Jun. 26, 2020

Related U.S. Application Data
(63) Continuation of application No. PCT/JP2018/047931, filed on Dec. 26, 2018.

(30) Foreign Application Priority Data
Dec. 27, 2017 (JP) 2017-250692
Dec. 27, 2017 (JP) 2017-250693

(51) Int. Cl. F27B 17/00; F27D 3/12; F27D 99/00

(52) U.S. Cl. CPC F27B 17/0016; F27B 2017/0091; F27D 99/0006; F27D 3/12

(57) ABSTRACT

The infrared baking device includes: a furnace chamber having an opening openable/closable by an opening/closing cover and allowing an internal space thereof to be tightly sealed; a baking object placement portion on which a baking object is to be placed and which is extractable/insertable through the opening; a heater lamp for heating the heating object by infrared rays; and a thermocouple provided at the baking object placement tray. A furnace wall of the furnace chamber is configured so that infrared rays from the heater lamp are collected and radiated to the tray. The thermocouple is provided in a contactor to contact with the tray. The tray and the contactor are made of the same material which absorbs the infrared rays.

### CROSS REFERENCE TO RELATED APPLICATIONS

This is a continuation of International Application No. PCT/JP2018/47931 filed on Dec. 26, 2018, claiming the Paris Convention priority based on Japanese Patent Application Nos. 2017-250692 and 2017-250693 filed on Dec. 27, 2017, the contents of these applications of which, including the specifications, the claims and the drawings, are incorporated herein by reference in their entirety.

### TECHNICAL FIELD

The present invention relates to an infrared baking device and an electronic component baking method using the same. More specifically, the present invention relates to an infrared baking device including: a furnace chamber having an opening openable/closable by an opening/closing cover and allowing an internal space thereof to be tightly sealed; a baking object placement portion on which a baking object is to be placed and which is extractable/insertable through the opening; a heater lamp for heating the baking object by infrared rays; and a thermocouple provided at the baking object placement portion, wherein a furnace wall of the furnace chamber is configured so that infrared rays from the heater lamp are collected and radiated to the baking object placement portion, and also, the present invention relates to an electronic component baking method using the infrared baking device.

### BACKGROUND ART

Conventionally, as an infrared baking device, the one at a laboratory level described in Japanese Laid-Open Patent Publication No. 2004-11938 has been known. Meanwhile, as an electronic component baking method, a baking tunnel type described in Japanese Laid-Open Patent Publication No. H07-309673 has been known.

### SUMMARY OF THE INVENTION

An infrared baking device according to the present invention includes: a furnace chamber having an opening openable/closable by an opening/closing cover and allowing an internal space thereof to be tightly sealed; a baking object placement portion on which a baking object is to be placed and which is extractable/insertable through the opening; a heater lamp configured to heat the baking object placement portion by radiating infrared rays thereto; and a thermocouple provided at the baking object placement portion, wherein a furnace wall of the furnace chamber is configured so that infrared rays from the heater lamp are collected and radiated to the baking object placement portion, the baking object placement portion is a tray, the thermocouple is provided in a contactor to contact with a vicinity of a center part of the tray, the tray and the contactor are made of the same material which absorbs the infrared rays, and the tray is heated by being irradiated with the infrared rays by the heater lamp from upper and lower sides of the tray.

In the above configuration, the tray is made of the same material which absorbs infrared rays. Therefore, even when the size of the tray is increased, the tray is irradiated with infrared rays from the heater lamp so that the temperature of the tray increases, whereby a lot of baking objects placed thereon can be baked by batch processing. In this case, when the thermocouple is merely embedded in the baking object, heat transfer is insufficient, and thus the temperature of the tray cannot be managed appropriately.

However, the thermocouple is provided inside the contactor made of the same material which absorbs infrared rays as the tray, and the contactor is in contact with the tray. Therefore, the contactor is heated in the same condition as the tray, so that the temperature of the tray can be managed appropriately.

### BRIEF DESCRIPTION OF THE DRAWINGS

FIG. 1 conceptually shows an infrared baking device;

FIG. 2 is a partially-cutaway perspective view of a furnace chamber;

FIG. 3 is a cross sectional view schematically showing the relationship between a baking furnace and an operation device;

FIG. 4 is a vertical sectional view of the furnace chamber;

FIG. 5 is a plan view of the furnace chamber;

FIG. 6A is a perspective view of a nozzle;

FIG. 6B is a cross sectional view of the nozzle;

FIG. 7 is a vertical sectional view schematically showing the relationship between the nozzle and a suction port;

FIG. 8 is a vertical sectional view around a temperature measurement portion; and

FIG. 9 is a graph showing an example of a temperature profile.

### DETAILED DESCRIPTION OF THE INVENTION

It is desirable that the tray is placed on the contactor. In addition, an end of the heater lamp may be fixed to the furnace wall such that airtightness of the internal space is maintained, and the tray and the heater lamp may be located in the internal space. Further, the opening/closing cover may be provided with a tray support arm for supporting the tray, and a contactor support arm having an end to which the contactor is attached, the tray support arm and the contactor support arm projecting laterally, and the contactor support arm may be configured to bring the contactor into contact with a lower surface of the tray placed on the tray support arm. In this case, it is desirable that the same material is any of ceramic, silicon carbide (SiC), and silicon carbide (SiC) coated with zirconia (ZrO₂).

In addition to the above configuration, a plurality of the heater lamps may be provided and formed in rod shapes, the furnace wall may have substantially the same sectional shape along a longitudinal direction of the heater lamps and may be configured so that the infrared rays are collected and radiated to the tray in directions perpendicular to the longitudinal direction, and the tray may be provided along the longitudinal direction. With this configuration, the heating condition for the tray can be set on a cross-section basis of each longitudinal-direction part, and therefore increase in the production amount can be easily made through extension in the longitudinal direction. Also, even when extension in the width direction of the tray is made, the temperature condition at each position in the longitudinal direction hardly changes. Therefore, even in the case of treating a lot of baking objects, temperature management can be appropriately performed and thus there is a significant advantage in terms of manufacturing management.

In such a case, it is desirable that a cooling nozzle for spraying cooling gas to the tray is provided in a vicinity of the tray. Thus, the tray can be immediately cooled and the baking objects placed on the tray can also be immediately cooled via the tray. Also, as described above, the temperature of the tray is increased by infrared rays from the heater lamp. Therefore, a lot of baking objects placed on the tray can be baked and cooled at high speed, and the manufacturing efficiency is further improved. Further, it is desirable that the cooling nozzle is provided under the tray.

In addition to the above configuration, it is desirable that the opening/closing cover is provided at a front side of the furnace chamber in a direction perpendicular to the longitudinal direction. In this case, at the opening/closing cover, the support arm supporting the tray, and the contactor may be provided so as to project laterally. Further, the furnace wall may be formed to be a parabola surface with a ray emission center of the heater lamp located at one focus thereof so as to reflect and radiate rays in parallel toward a center of the furnace chamber, a slider configured to move the opening/closing cover horizontally may be further provided, and the slider may move the opening/closing cover horizontally to set a center of the tray in a vicinity of the center of the furnace chamber. This configuration allows the tray to be quickly extracted/inserted, and thus has an advantage in terms of manufacturing efficiency.

In addition, the tray support arm may be made of a material, such as quartz, that does not obstruct radiation of the infrared rays. This is because heat transfer to the opening/closing cover is prevented and radiation of infrared rays to the tray is not obstructed, whereby temperature control and response are improved.

In addition to the above, the opening/closing cover may be provided at each of a front side and a rear side of the furnace chamber in a direction perpendicular to the longitudinal direction. It is possible to very easily perform cleaning in the furnace by opening the opening/closing covers on both of the front and rear sides of the furnace chamber. In addition, the tray may have a flat upper surface and have a flange for preventing dropping of the baking object around a periphery thereof, and the tray may be formed to be horizontally long and have the same sectional shape, along the longitudinal direction.

Meanwhile, an electronic component baking method for an electronic component such as MLCC, using the infrared baking device according to any one of the above configurations further including a lifting/lowering device, includes: laying multiple electronic components which are the baking objects, over the tray; setting the tray on a tray support arm provided to the opening/closing cover, by the lifting/lowering device; and closing the opening/closing cover and performing baking by the heater lamp. With this configuration, the tray over which multiple electronic components are laid can be quickly extracted/inserted from/into the furnace chamber by the lifting/lowering device without being tilted, and thus the production efficiency is improved. As the lifting/lowering device, a cylinder or a robot arm can be used.

In addition to the above configuration of the baking method, the infrared baking device may further include a gas supply port allowing gas to be supplied to the furnace chamber therethrough and a gas exhaust port allowing the gas to be discharged from the furnace chamber therethrough, and the baking method may further include performing baking by the heater lamp while forming a uniform supplied gas layer by supplying the gas through the gas supply port and discharging the gas through the gas exhaust port as appropriate. Owing to the gas layer, baking can be performed in an appropriate atmosphere.

In addition, the infrared baking device may further include a cooling nozzle provided in a vicinity of the tray, and the baking method may further include: stopping heating by the heater lamp; cooling the tray by spraying the cooling gas from the cooling nozzle to the tray; and opening the opening/closing cover to extract the tray. By supplying the cooling gas, the temperature of the tray can be quickly decreased, and thus the baking period is shortened, whereby production efficiency can be further improved.

The above configurations of the infrared baking device and the electronic component baking method using the same according to the present invention enable the temperature profile in baking to be easily adjusted, whereby a lot of baking objects can be treated by batch processing.

Other objects, structures, and effects of the present invention will become apparent from embodiments of the invention shown below.

### DESCRIPTION OF EMBODIMENTS

Next, embodiments of the present invention will be described in more detail with reference to the accompanying drawings as necessary.

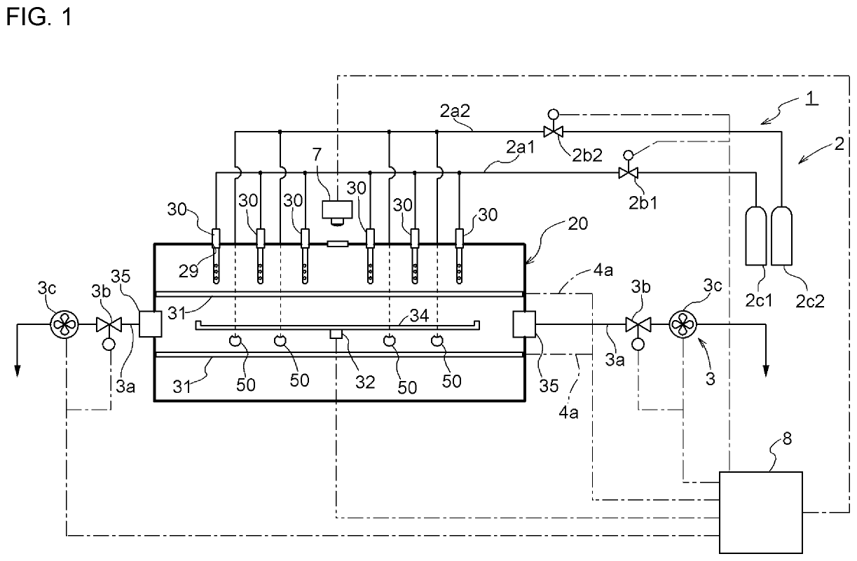

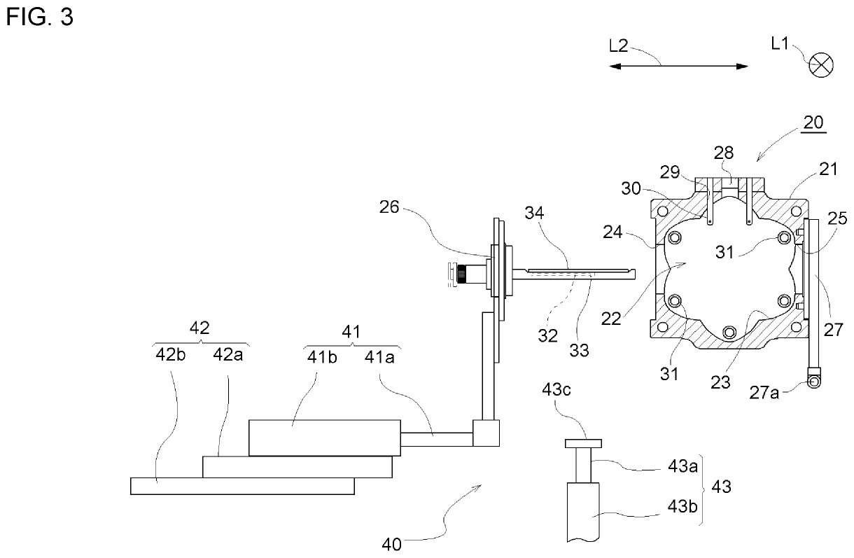

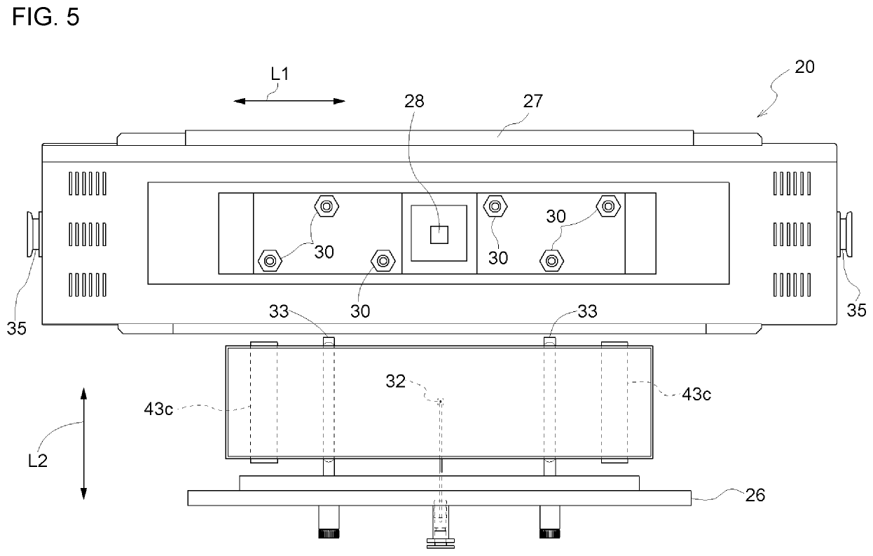

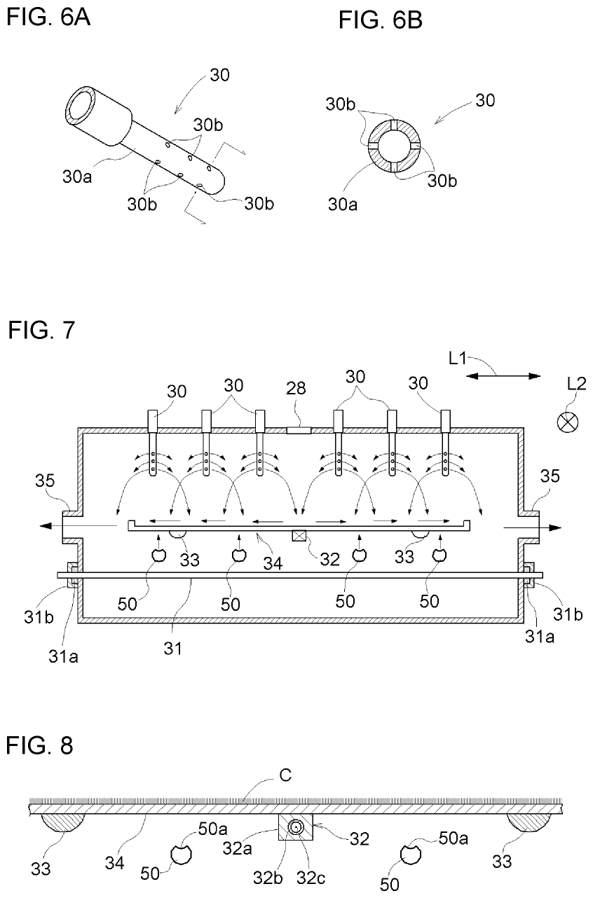

As shown in FIGS. 1 to 8, an infrared baking device 1 according to the present invention includes a gas supply system 2, a gas discharge system 3, a camera 7, a control device 8, and a baking furnace 20. A tray 34 which is a baking object placement portion is formed in a rectangular tray shape having a flange and elongated in a horizontal direction. Multiple multi-layer ceramic capacitors (MLCC) which are baking objects are placed on the tray 34, to be subjected to baking treatment.

The gas supply system 2 includes a supply path 2a1, a solenoid valve 2b1, and a gas cylinder 2c1, and supplies gas in the gas cylinder 2c1 to a plurality of nozzles 30 which are gas supply ports provided at an upper part of the baking furnace 20. Further, the gas supply system 2 includes a supply path 2a2, a solenoid valve 2b2, and a gas cylinder 2c2, and supplies cooling gas in the gas cylinder 2c2 to a plurality of cooling nozzles 50 provided directly under the tray 34. The cooling gas is, for example, nitrogen (N₂) gas. On the other hand, the gas discharge system 3 includes discharge paths 3a, solenoid valves 3b, and fans 3c, and forcibly discharges the gas supplied from the nozzles 30, through gas exhaust ports 35, 35 at the left and right sides. The solenoid valves 2b1, 2b2, 3b and the fans 3c are each controlled by the control device 8 to perform supply and discharge of gas in accordance with a program.

Heater lamps 31 heat the above tray 34 by infrared rays. Meanwhile, a temperature measurement portion 32 measures the temperature of the tray 34 by a thermocouple. Using a temperature monitor based on the temperature measurement portion 32, heating power of the heater lamps 31 is controlled so that heating, baking, or cooling is performed in accordance with a programmed temperature profile. In FIG. 1, dotted-dashed lines indicate an electric control system. All the components connected to these lines send signals or data to the control device 8, and are controlled by the control device 8. A camera 7 sequentially records the condition in the baking furnace 20, into the control device 8. That is, the control device 8 can easily set/change the temperature profile which indicates when and at what temperature heating or cooling is to be performed in baking, and both of the timings of supply and discharge of gas, thereby executing heating or cooling, and can record images from the camera 7 together with temperature data of the execution result.

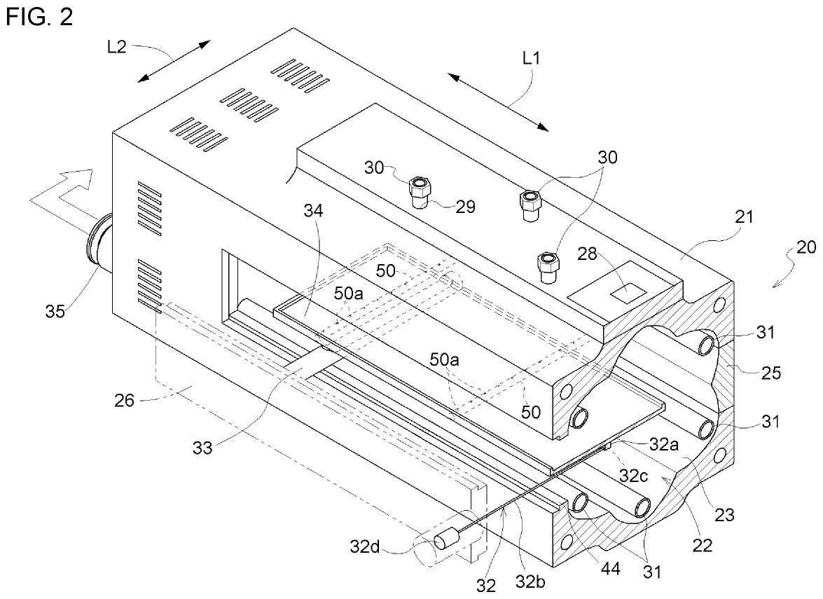

As shown in FIGS. 2 to 4, the baking furnace 20 has a furnace wall 23 having, in a sectional view thereof, an inner surface in which parabolas having six vertices are combined like a petal shape, and having the same shape with respect to a left-right longitudinal direction L1. The rod-shaped heater lamp is provided along the longitudinal direction L1 such that a filament present at the center thereof is located at a focus F (F1, F2a, F2b, F3a, F3b) of each parabola. Thus, infrared rays emitted from the filaments of the heater lamps 31 at the focuses F are reflected by the furnace wall 23 which is a reflection surface, and advance in parallel to concentrate at the center part in an internal space 22 of the furnace chamber 21, thereby equally heating this part.

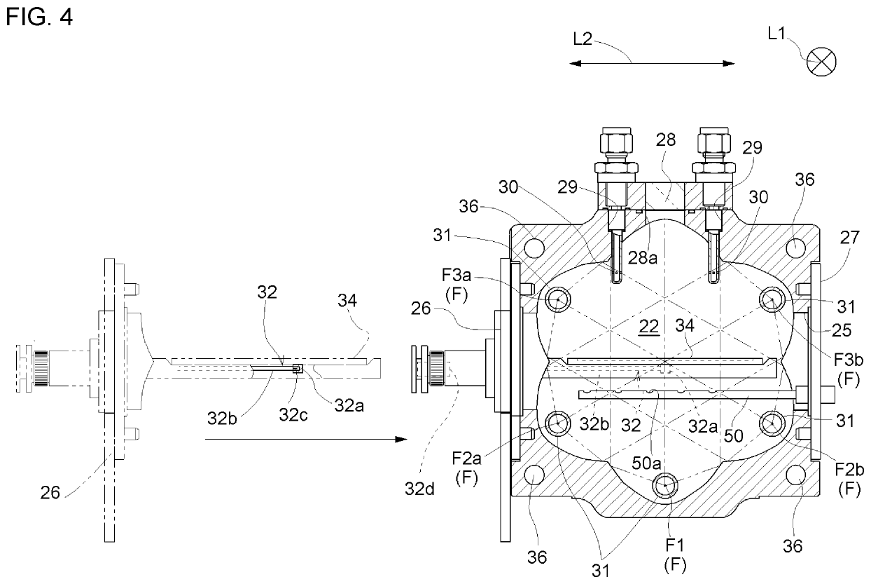

In particular, this point will be described with reference to FIG. 4. In FIG. 4, the heater lamps 31 are provided at four locations on the left and right sides and one location on the lower side. Among paths of rays emitted from the focuses F (F1, F2a, F2b, F3a, F3b) of the parabolas at which their filaments are located, the paths passing near ends of the parabolas and the paths passing through the center are indicated by two-dot dashed lines. With the rays from the left and right focuses F2a, F2b, F3a, F3b, the tray 34 is present within an area of four rhombuses at the center part, and thus it is found that the tray 34 is equally heated. In addition, from the focus F1 on the lower side, the center part including a contactor 32a is heated, and thus temperature measurement can be accurately performed. It is noted that, besides direct radiation from the focuses F to the tray 34, rays incident on the surface of the parabola in the area of another focus are reflected by that surface, and thus are also radiated to the tray 34.

Therefore, the tray 34 can be equally heated even if the tray 34 has a width in a front-rear direction L2 perpendicular to the longitudinal direction L1. It is noted that the sectional shape may be an elliptic shape instead of the parabola shape, and the filament of the heater lamp 31 may be located at one of the focuses thereof and the center of the tray 34 may be located at the other focus. However, the parabola shape is more excellent in uniformity of heating over the entire tray 34. In the case of the elliptic shape, increasing the ray emission area of the filament reduces unevenness of heating.

The heater lamp 31 is provided as follows: although not shown, a helical filament which is a heat generation portion (ray emission portion) is stored along the longitudinal direction L1 inside a quartz tube having a straight tube shape, the quartz tube is supported on the left and right sides, and halogen gas or the like is sealed inside the quartz tube. Power is supplied from left and right terminals, and the heat generation condition is controlled via a thyristor or the like by the above control device 8. When the filament emits rays by being supplied with power, infrared rays emitted therefrom are reflected by the above furnace wall 23, whereby heating is performed as described above. Five heater lamps 31 are provided at locations excluding the topmost location. In the furnace chamber 21, cooling water paths 36 are formed as appropriate, and cooling water flows therethrough to prevent overheating of the furnace chamber 21.

In the furnace chamber 21 of the baking furnace 20, a front opening 24 and a rear opening 25 are provided side by side in the above front-rear direction L2, thus facilitating cleaning of the internal space 22, and the like. The openings are respectively closed by a front cover 26 and a rear cover 27 in a sealed state. A through hole 28a is formed at the center part of the furnace chamber 21, an observation window 28 made of a transparent heat-resistant material such as quartz is provided at the through hole 28a, and an image is taken therethrough by the above camera 7. Terminal portions at both ends of each of the heater lamps 31 (only one of them is schematically shown as a representative in FIG. 7) penetrate the furnace chamber 21 to protrude outside, and a seal 31a and a fixation cap 31b are provided at each end to keep airtightness in the internal space 22.

The rear cover 27 is mainly used only at the time of cleaning, and ordinary extraction/insertion of the tray 34 is conducted by opening/closing the front cover 26. The rear cover 27 is supported by a hinge on the lower side, and is opened/closed with the hinge as a fulcrum. On the other hand, the front cover 26 is horizontally moved by an operation device 40, so as to be opened/closed. The operation device 40 includes an opening/closing actuator 41 having a piston rod 41a and a cylinder 41b, and a second opening/closing actuator 42 having a movable portion 42a and a fixed portion 42b. The opening/closing actuator 41 opens the front cover 26 by contracting. The second opening/closing actuator 42 further retracts the front cover 26 by contracting, so as to facilitate cleaning of the furnace chamber 21.

The tray 34 has a flat upper surface and has a flange for preventing dropping of the MLCC around a periphery thereof. The tray 34 is formed to be horizontally long and have substantially the same sectional shape, along the longitudinal direction L1. In addition, the temperature measurement portion 32 is configured such that a support arm 32b is inserted into a hole formed in a small block-shaped contactor 32a to contact with the above tray 34 and a thermocouple joining portion 32c is provided therein, and the temperature measurement portion 32 is connected to the above control device 8 via a connector 32d using a cable. The tray 34 and the contactor 32a are both made of the same material which absorbs infrared rays, and for example, ceramic, silicon carbide (SiC), silicon carbide (SiC) coated with zirconia (ZrO₂), or the like may be used.

In addition, directly under the tray 34, the plurality of cooling nozzles 50 for spraying cooling gas toward the lower surface of the tray 34 are provided at appropriate intervals along the longitudinal direction L1. In the cooling nozzle 50, a plurality of nozzle holes 50a are formed at the upper surface of the nozzle 50 at appropriate intervals along the nozzle longitudinal direction (front-rear direction L2). Thus, the entire tray 34 can be cooled equally and immediately. As described above, the temperature of the tray 34 is increased by infrared rays from the heater lamps 31. In the infrared baking device 1 according to the present invention, a baking object C itself is not directly heated/cooled but is heated/cooled via the tray 34, whereby, in particular, in the case of baking a lot of fine baking objects C such as MLCC, immediate and uniform heating/cooling can be performed, and variation among individual baking objects C is suppressed. In addition, since the temperature measurement portion 32 is in contact with the lower surface of the tray 34, temperature management can be appropriately performed.

The front cover 26 is provided with a pair of support arms 33 made of a heat-resistant material such as quartz. These support arms 33 are made of a material that hardly absorbs infrared rays (material having high transmittance for infrared rays), so that heat transfer to the front cover 26 is prevented and radiation of infrared rays to the tray 34 is not obstructed, thus improving temperature control and response. The above support arm 32b is located between the support arms 33, 33, and the above contactor 32a is located between the support arms 33, 33. At the time of setting the tray 34, a piston rod 43a is thrusted out from a cylinder 43b by a lifting/lowering actuator 43 which is a lifting/lowering device so that a pair of support portions 43c, 43c are located higher than the support arms 33, 33, and then the tray 34 is transferred thereto. Next, the piston rod 43a is retracted to lower the tray 34 so that the tray 34 is transferred to be placed on the support arms 33, 33.

At the upper surface of the furnace chamber 21, a plurality of through holes 29 are arranged along the longitudinal direction L1 so as to be alternately staggered in the front-rear direction L2, and the plurality of nozzles 30 which are gas supply ports are attached thereto in an airtight state. The nozzles 30 are made of a material that hardly absorbs infrared rays (material having high transmittance for infrared rays), e.g., a quartz tube or the like, so that radiation of infrared rays to the tray 34 is not obstructed. Further, a plurality of nozzle holes 30b are formed in the circumference of a tubular nozzle body 30a so that gas spreads therearound. Also in the vicinity of the observation window 28, the nozzles 30 are set in the arrangement as described above, and owing to the plurality of nozzle holes 30b, gas flows down also in the vicinity of the observation window 28.

With the above arrangement of the nozzles 30, the gas spreads equally over the flat tray 34. Further, the gas is forcibly discharged through each of the gas exhaust ports 35, 35 provided at almost the same height as the tray 34 on the left and right sides in the longitudinal direction L1 of the tray 34. Owing to the above combination of supply and discharge of the gas, the gas layer spreads uniformly over the baking objects C on the tray 34. In the case of MLCC, in order to prevent oxidation of a paste and escape of a solvent due to debinder or the like, the gas layer is always renewed by flowing while being uniformed, whereby such adverse effects can be prevented.

Next, a method for using the infrared baking device 1 will be described, using an example in which an MLCC having an electrode to which a copper paste containing glass frit is applied is baked as a baking object.

First, the baking objects C are laid over the tray 34, and the tray 34 is moved and placed onto the pair of support portions 43c, 43c of the lifting/lowering actuator 43 by a robot arm or the like. Then, the piston rod 43a is retracted to lower the tray 34, so that the tray 34 is transferred to be placed on the support arms 33, 33. Next, the opening/closing actuator 41 is extended to close the front cover 26 in an airtight state and set the tray 34 at the center in the furnace chamber 21.

Next, the heater lamps 31 are turned on to start heating, and the solenoid valve 2b1 is opened to supply nitrogen gas to the nozzle 30. At the same time, the solenoid valves 3b and the fans 3c are operated to discharge the gas inside the furnace chamber 21, through the gas exhaust ports 35. The heating by the heater lamps 31 is performed in accordance with the programmed profile so that the temperature and the time period are adjusted as appropriate at the time of performing debinder, melting of metal, or the like.

When the baking is finished, energization of the heater lamps 31 is lowered or stopped to decrease the temperature. Further, as necessary, nitrogen gas as cooling gas may be sprayed from the cooling nozzles 50 to the tray 34, to promote cooling of the baking objects C and the tray 34. Through a procedure reverse to the case of setting, the above operation devices and the like are operated to transfer the tray, whereby baking operation is completed.

Next, other possible embodiments of the present invention will be described. The same members are denoted by the same reference characters.

In the above embodiment, the cooling nozzles 50 are provided directly under the tray 34. However, the position of the cooling nozzles 50 is not limited to the position directly under the tray 34. For example, the cooling nozzles 50 may be provided obliquely downward of the tray 34. By providing the cooling nozzles 50 on the lower side of the tray 34 as described above, it is possible to efficiently cool the tray 34 without influencing the baking object C. It is noted that the cooling nozzles 50 may be provided in the vicinity of the tray 34 as long as the baking object C is not influenced.

In the above embodiment, a copper paste is used in the MLCC. However, a silver paste may be used. In this case, other than nitrogen, oxygen may be used as the gas.

In addition, in the above embodiment, the MLCC in which a copper paste containing glass frit is applied as an external electrode has been described as the baking object C. However, the baking object C and the baking process therefor are not limited to the above embodiment. The infrared baking device 1 according to the present invention can be used also for, for example, a chip baking process which is a process before the baking process for the external electrode of the MLCC.

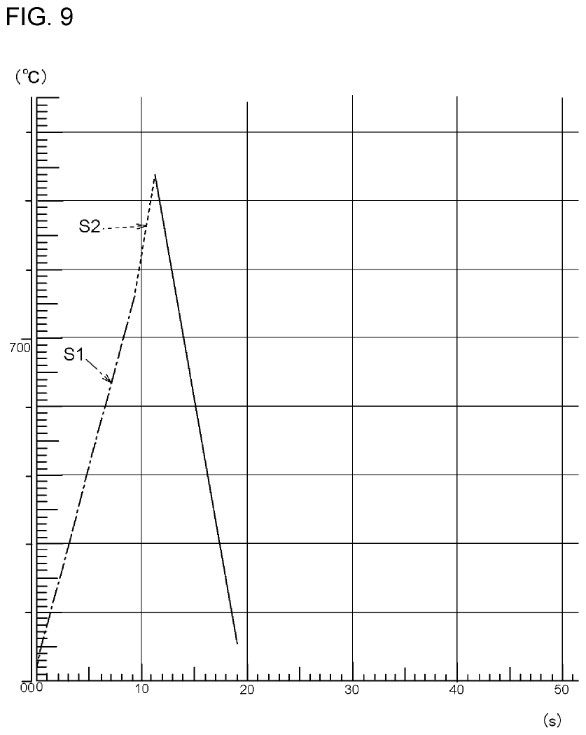

In the chip baking process, if baking is rapidly performed after debinder treatment, cracking or expansion occurs in the chip. Therefore, preliminary baking for gradually increasing the temperature at a constant rate is performed before main baking for baking and hardening metal and ceramic. The main baking and the preliminary baking are often performed in separate processing steps. However, in the infrared baking device 1 according to the present invention, the temperature of the tray 34 is increased by infrared rays from the heater lamps 31 as described above, and thus immediate and accurate temperature control can be performed. Therefore, for example, as shown in a temperature profile in FIG. 9, it is also possible to continuously execute (control) a preliminary baking step S1 of gradually increasing the temperature at a constant rate and a main baking step S2 of performing heating rapidly. In addition, it is also possible to cool the tray 34 by cooling gas from the cooling nozzles 50, as well as heating. Thus, since the control for increasing the temperature and decreasing the temperature is easy, the degree of freedom in process designing is high, and even if a processing step is omitted, reduction (variation) in product quality can be suppressed and production efficiency can be improved. It is noted that, although the process for the MLCC has been described as an example, the same applies also in the case of another electronic component (baking object).

In the above embodiment, the gas to be supplied into the baking furnace 20 and the gas for cooling have been described separately from each other. However, two kinds of gases may be used by being switched therebetween. As a matter of course, the kinds of gases are not limited to two kinds, and one or a plurality of kinds of gases may be used. In addition, it is also possible to perform heating in a low vacuum (weak vacuum) state by strongly performing gas discharge.

The configuration of the infrared baking device 1 may be modified into configurations other than the above, without departing from the scope of the invention. For example, although the sectional shape of the furnace wall has been shown as six parabolas, a shape formed by combining five or four parabolas may be employed.

It is noted that, while the embodiments of the present invention are configured as described above, further comprehensively, configurations shown below may be included. An object of the invention having the configurations shown below is to provide an infrared baking device capable of, while enabling the temperature profile in baking to be easily adjusted and enabling batch processing for a lot of baking objects, maintaining the atmosphere of supplied gas uniformly over the baking objects, and an electronic component baking method using the infrared baking device.

In order to attain the above object, the infrared baking device includes: a furnace chamber having an opening openable/closable by an opening/closing cover and allowing an internal space thereof to be tightly sealed; a baking object placement portion on which a baking object is to be placed and which is extractable/insertable through the opening; a heater lamp configured to heat the baking object by infrared rays; a gas supply port allowing gas to be supplied to the furnace chamber therethrough; and a gas exhaust port allowing the gas to be discharged from the furnace chamber therethrough, wherein a furnace wall of the furnace chamber is configured so that the infrared rays from the heater lamp are collected and radiated to the baking object placement portion, the baking object placement portion is a wide tray, the gas supply ports cause the gas to flow down from a plurality of locations above the tray onto the tray, and the gas exhaust ports are provided on both lateral sides of the tray to discharge the flowing-down gas therethrough.

In the above configuration, since the baking object placement portion is a wide tray, a lot of baking objects can be placed on the tray and subjected to baking treatment in large numbers by batch processing. The gas supply ports cause the gas to flow down from the plurality of locations above the wide tray onto the tray, and as shown in FIG. 7, the gas spreads uniformly over the upper surface of the tray. In addition, the gas exhaust ports are provided on not only one side of the wide tray, but both lateral sides thereof, to discharge the flowing-down gas therethrough. Owing to such an action, the gas supplied uniformly over the tray flows as a layer on the baking objects, whereby baking can be performed in the uniform gas atmosphere.

Also, by supplying different gas through the gas supply ports and discharging gas through the gas exhaust ports, the gas inside the furnace chamber can be completely exchanged. In addition, by discharging gas through the gas exhaust ports, it is also possible to make the inside of the furnace chamber into a vacuum state. Also in gas exchange and complete gas discharge, the gas is discharged from both sides, and therefore the gas does not stagnate in the furnace chamber and the baking object can be prevented from unintentionally contacting with the gas.

In addition, heating in this baking device is performed such that, instead of using heat transfer from the surrounding gas, infrared rays are radiated from the heater lamps to the tray, thereby directly heating the tray. Thus, without being influenced by the thermal capacity of the surrounding gas, it is possible to select heating/non-heating very quickly, and it is possible to perform heating/cooling within a short time. Therefore, in manufacturing of an electronic component such as MLCC, it is possible to perform fine control of a temperature increase profile so as to prevent drawback of glass frit described above.

Further, in addition to the above configuration, a plurality of the heater lamps may be provided and formed in rod shapes, the furnace wall may have substantially the same sectional shape along the longitudinal direction of the heater lamps and may be configured so that infrared rays are collected and radiated to the tray in directions perpendicular to the longitudinal direction, the tray may be provided along the longitudinal direction, and the exhaust ports may be provided at respective ends in the longitudinal direction. With this configuration, the heating condition for the tray can be set on a cross-section basis of each longitudinal-direction part, and therefore increase in the production amount can be easily made through extension in the longitudinal direction. Also, even when extension in the width direction of the tray is made, gas is very stably supplied along the longitudinal direction of the tray owing to discharge through the gas exhaust ports on both sides. Therefore, both of heating and the gas atmosphere are very stable, and thus there is a great advantage in terms of manufacturing management.

In addition, it is desirable that the opening/closing cover is provided in a direction perpendicular to the longitudinal direction. This is because gas discharge paths are not obstructed and also, extraction/insertion can be quickly performed in the short-side direction perpendicular to the longitudinal direction of the tray.

It is desirable that each gas supply port has a plurality of ejection holes provided in a periphery of a tubular body thereof protruding downward. This is because gas can be uniformly supplied over the tray. In this case, it is desirable that the tubular body is made of a material, such as quartz, that has high transmittance for infrared rays. This is because the infrared rays can be radiated to the tray without being obstructed by the tubular body. In addition, the gas supply ports may be arranged along the longitudinal direction and alternately staggered in a direction perpendicular to the longitudinal direction. With this arrangement, formation of the gas layer through supply and discharge of gas is appropriately performed.

An observation window may be provided at the center of an upper part of the furnace chamber, at least two of the gas supply ports may be respectively provided on the lateral sides of the observation window, and the gas may be sprayed toward the observation window side. This is because the gas is also supplied to the vicinity of the observation window, whereby observation can be performed at a part around the center where a gas layer is most unlikely to be formed, and also, since the gas is supplied toward the observation window side, uniformity of the gas layer at this part is enhanced.

In addition to the above, the opening/closing cover may be provided at each of a front side and a rear side of the furnace chamber in a direction perpendicular to the longitudinal direction. Thus, it is possible to clean the inside of the furnace very easily by opening both opening/closing covers at the front and rear sides of the furnace chamber.

An electronic component baking method for an electronic component such as MLCC, using the infrared baking device according to any of the above configurations, includes: laying multiple electronic components which are the baking objects, over the tray; and performing baking by the heater lamp while forming a uniform supplied gas layer by supplying gas through the gas supply port and discharging the gas through the gas exhaust port as appropriate.

In this method, a thermocouple may be provided in a vicinity of the tray, an image of the electronic components may be captured through the observation window, and the capturing result may be stored together with a temperature profile of the thermocouple, so as to be stored as a lot record on a tray basis. Since image capturing and association of an accurate temperature profile with each lot, which are absolutely impossible in the above-described tunnel-type baking, can be performed, it is possible to appropriately perform product quality control for defective products and the like.

In addition, first gas may be supplied through the gas supply port while the first gas is completely discharged through the gas exhaust port, and second gas may be supplied through the gas supply port. Such gas control cannot be performed by the conventional tunnel-type method.

The infrared baking device and the electronic component baking method using the same configured as described above make it possible to, while enabling the temperature profile in baking to be easily adjusted and enabling batch processing for a lot of baking objects, maintain the atmosphere of supplied gas uniformly over the baking objects. Thus, it becomes possible to very appropriately perform production management and product quality control for electronic components such as MLCC, thus enabling improvement in production yield and provision of novel product quality.

The infrared baking device according to the present invention can be used for baking electronic components such as MLCC, or members, other than such electronic components, for which the temperature and the gas atmosphere need to be controlled.

While the embodiments of the present invention have been described above, these are merely examples thereof, a person skilled in the art may make various modifications thereof, and such modifications are included in the scope of the claims.

What is claimed is:

1. An infrared baking device comprising:
a furnace chamber having an opening openable/closable by an opening/closing cover and allowing an internal space thereof to be tightly sealed;
a baking object placement tray on which a baking object is to be placed and which is extractable/insertable through the opening;
a heater lamp configured to heat the tray by radiating infrared rays thereto; and
a thermocouple provided at the tray, wherein
a furnace wall of the furnace chamber is configured so that infrared rays from the heater lamp are collected and radiated to the tray,
the thermocouple is provided in a contactor to contact with a vicinity of a center part of the tray,
the tray and the contactor are made of the same material which absorbs the infrared rays, and
the tray is heated by being irradiated with the infrared rays by the heater lamp from upper and lower sides of the tray.

2. The infrared baking device according to claim 1, wherein
the tray is placed on the contactor.

3. The infrared baking device according to claim 1, wherein
an end of the heater lamp is fixed to the furnace wall such that airtightness of the internal space is maintained, and the tray and the heater lamp are located in the internal space.

4. The infrared baking device according to claim 1, wherein
the opening/closing cover is provided with a tray support arm for supporting the tray, and a contactor support arm having an end to which the contactor is attached, the tray support arm and the contactor support arm projecting laterally, and
the contactor support arm is configured to bring the contactor into contact with a lower surface of the tray placed on the tray support arm.

5. The infrared baking device according to claim 1, wherein
the same material is any of ceramic, silicon carbide (SiC), and silicon carbide (SiC) coated with zirconia (ZrO₂).

6. The infrared baking device according to claim 1, wherein
a plurality of the heater lamps are provided and formed in rod shapes,
the furnace wall has substantially the same sectional shape along a longitudinal direction of the heater lamps and is configured so that the infrared rays are collected and radiated to the tray in directions perpendicular to the longitudinal direction, and
the tray is provided along the longitudinal direction.

7. The infrared baking device according to claim 1, wherein
a cooling nozzle for spraying cooling gas to the tray is provided in a vicinity of the tray.

8. The infrared baking device according to claim 7, wherein
the cooling nozzle is provided under the tray.

9. The infrared baking device according to claim 1, wherein
the opening/closing cover is provided at a front side of the furnace chamber in a direction perpendicular to the longitudinal direction.

10. The infrared baking device according to claim 9, wherein
the furnace wall is formed to be a parabola surface with a ray emission center of the heater lamp located at one focus thereof so as to reflect and radiate rays in parallel toward a center of the furnace chamber,
a slider configured to move the opening/closing cover horizontally is further provided, and
the slider moves the opening/closing cover horizontally to set a center of the tray in a vicinity of the center of the furnace chamber.

11. The infrared baking device according to claim 4, wherein
the tray support arm is made of a material that does not obstruct radiation of the infrared rays.

12. The infrared baking device according to claim 1, wherein
the opening/closing cover is provided at each of a front side and a rear side of the furnace chamber in a direction perpendicular to the longitudinal direction.

13. The infrared baking device according to claim 6, wherein
the tray has a flat upper surface and has a flange for preventing dropping of the baking object around a periphery thereof, and the tray is formed to be horizontally long and have the same sectional shape, along the longitudinal direction.

14. An electronic component baking method for an electronic component such as MLCC, using the infrared baking device according to claim 1 further comprising a lifting/lowering device, the method comprising:
laying multiple electronic components which are the baking objects, over the tray;
setting the tray on a tray support arm provided to the opening/closing cover, by the lifting/lowering device; and
closing the opening/closing cover and performing baking by the heater lamp.

15. The electronic component baking method using the infrared baking device according to claim 14, the infrared baking device further comprising a gas supply port allowing gas to be supplied to the furnace chamber therethrough and a gas exhaust port allowing the gas to be discharged from the furnace chamber therethrough, the method further comprising:
performing baking by the heater lamp while forming a uniform supplied gas layer by supplying the gas through the gas supply port and discharging the gas through the gas exhaust port as appropriate.

16. The electronic component baking method using the infrared baking device according to claim 14, the infrared baking device further comprising a cooling nozzle provided in a vicinity of the tray, the method further comprising:
stopping heating by the heater lamp;
cooling the tray by spraying cooling gas from the cooling nozzle to the tray; and
opening the opening/closing cover to extract the tray.
